(19) United States
(12) Patent Application Publication
(10) Pub. No.: US 2018/0121300 A1
(43) Pub. Date: May 3, 2018

(54) RESILIENT MEMORY FABRIC

(71) Applicants: Luis Miguel VAQUERO GONZALEZ, Bristol (GB); Suksant SAE LOR, Bristol (GB); Hewlett Packard Enterprise Development LP, Houston, TX (US)

(72) Inventors: Luis Miguel Vaquero Gonzalez, Bristol (GB); Suksant Sae Lor, Bristol (GB)

(21) Appl. No.: 15/573,093

(22) PCT Filed: Sep. 24, 2015
(86) PCT No.: PCT/EP2015/072043

§ 371 Date: Nov. 9, 2017

(51) Int. Cl. G06F 11/20

(52) U.S. Cl. CPC G06F 11/201; G06F 2201/805

(57) ABSTRACT

Examples of a resilient memory fabric comprise a network of memory components, each memory component comprising a respective address space, wherein the memory fabric comprises the aggregated respective memory as a single addressable memory space. A first memory component of the network of memory components may comprise a first memory local non-transitory machine readable storage medium that stores a set of labeled routes to other memory components in the memory fabric; and a first memory processor that executes machine-readable instructions that cause the first memory component to route data along a selected labeled route.

### BACKGROUND

Some computing systems use memory systems comprising a plurality of interconnected memory components. The memory components may be distributed to different locations, with some memory components being located close to the computing systems and some other memory components being located at remote locations, or co-located in various numbers, as desired.

### BRIEF DESCRIPTION OF THE DRAWINGS

The following detailed description references the drawings, wherein:

FIG. 1 is a block diagram of an example resilient memory fabric;

FIG. 2 is an block diagram of an example resilient memory fabric;

FIG. 3 is a block diagram of an example resilient memory fabric;

FIG. 4 is a flowchart of an example method for managing a resilient memory fabric;

FIG. 5 is a flowchart of an example method for managing a resilient memory fabric; and

FIG. 6 is a flowchart of an example method for failure recovery in a resilient memory fabric.

### DETAILED DESCRIPTION

The following detailed description refers to the accompanying drawings. Wherever possible, the same reference numbers are used in the drawings and the following description to refer to the same or similar parts. While several examples are described in this document, modifications, adaptations, and other implementations are possible. Accordingly, the following detailed description does not limit the disclosed examples. Instead, the proper scope of the disclosed examples may be defined by the appended claims.

As mentioned above, some computing systems use memory systems comprising a plurality of interconnected memory components. The memory components may be distributed to different locations, with some memory components being located close to the computing systems and some other memory components being located at remote locations, or co-located in various numbers, as desired.

Memory systems are being developed which comprise a plurality of inter-connected memory components whose individual memory address spaces are aggregated and exposed (e.g. to processors/computing modules, and/or other memory components)—through entry points acting similarly to gateways in computer networks—as if the whole network of memory components were but a single memory component having a uniform memory space. As used herein, a memory fabric may be comprise such a network of memory components.

In such memory fabrics, the use of optical interconnects to connect memory components to one another increases the speed of signal transmission between components and makes it feasible to manage a group of memory components as a single memory resource even in cases where the group comprises a high number of memory components distributed over a large physical space. Thus, for example, the memory fabric could extend over plural racks in a data centre, over plural data centers, etc.

A memory fabric may treat memory as if it were a routable resource (treating memory addresses somewhat in the way that IP networks handle IP addresses). The memory fabric handles memory traffic (e.g., items routed over the memory fabric). Memory traffic may comprise, for example,: memory access requests and other relevant messages/information to facilitate access, allocation, configuration and the like of the memory fabric, as well as data being read from/written to the memory components of the memory fabric.

A memory component may receive requests for read or write access, may route a request to other memory components, may access memory addresses in response to a read or write request, and/or may otherwise facilitate management, communication, or storage of data. For example, responsive to a memory request (e.g., a read or write access request) being requested to a memory address in a memory fabric, a memory component may transmit a request to make a memory access along a path between one or more other memory components to a target memory component, and the target memory component (responsible for the memory address targeted in the request) may access the correct memory address

The memory components of the memory fabric may implement a routing protocol to determine the physical links that are used to route a memory request over the memory fabric to the target memory component. The memory fabric may perform steps of the fabric routing protocol to establish and use routing tables that specify which route to use to transmit a request from the memory component towards a particular destination point in the fabric. The route may, for example, be specified in terms of an output port which the memory component should use to forward the memory request towards the target memory component.

Physical link failures may occur when a memory component of the memory fabric fails or a physical link connecting two memory components itself fails because of a software error, a hardware problem, or a link disconnection. Failures may occur for a variety of reasons, including bursts of traffic that cause a high degree of loss of memory-addressing requests or high, variable latencies. Software applications that access a memory fabric may perceive failures as either outages or performance failures.

Certain memory fabrics may implement fabric routing protocols that are based on the assumption that there is only a single route to transmit a request from one particular memory component to another memory component in the fabric. This may be a valid assumption in the case of a small, static and/or carefully designed fabric. In such a case, the fabric routing protocol may cause the memory components to hold details of only one route to each potential destination. However, if a problem (outage, performance failure) arises somewhere along the single route designated in the routing table, then it may become impossible to transmit a memory-addressing request to its intended destination. Memory fabrics of this type are not resilient in the face of outages and performance failures.

Furthermore, certain memory fabrics may be large (i.e. they may involve a large number of memory components) and/or they may have a topology that does not result from conscious design (for example because memory components can join/leave the fabric in an ad hoc manner). As a result there may be a plurality of routes available for transmission of a request from one point to another, in particular as the size of the memory fabric increases. However, bandwidth issues and latency issues may occur responsive to a memory component (or the memory fabric itself) trying to determine alternative paths after a failure occurs. Further, some memory fabric routing protocols may include mechanisms which inhibit search or adoption of alternative paths after a failure has been discovered until the failure persists for a predetermined time period, in order to enhance the stability of routing with a large memory fabric.

To address the technical challenges of maintaining a resilient memory fabric in situations of link or memory component failure, each memory component in the memory fabric may comprise a local non-transitory machine readable storage medium that stores a set of labeled routes for the other memory components in the memory fabric. The set of labeled routes may comprise multiple routes to a particular memory component, where a first labeled route may be indicated as a primary route and the other labeled routes may be indicated as alternative routes.

Each memory component may pre-determine a set of routes to other memory components in the memory fabric. For example, a memory component may determine a set of routes to the other memory components and may label the determined set of routes. A route may comprise, for example, an ordered series of memory components and corresponding output ports. The label may comprise, for example, an identification of a route, an identification of the destination memory component of the route, a cost metric of the route, a number of memory components in the route, and/or other information related to the route. The memory component may determine and label the set of routes by performing routing to each of the other memory components, determining a cost metric for each route, and assigning a label to the route with the lowest determined cost metric.

Responsive to determining and labeling the set of routes, the memory component may then send information about the labeled routes to its neighbor memory components, and may receive information about labeled routes from each of its neighbors. The memory component may revise its labeled routes based on the received information by determining if a labeled route to a destination memory component received from a neighbor has a lower cost metric than its labeled route to that destination memory component. The previously labeled route may be maintained in storage as an alternative route to that destination memory component.

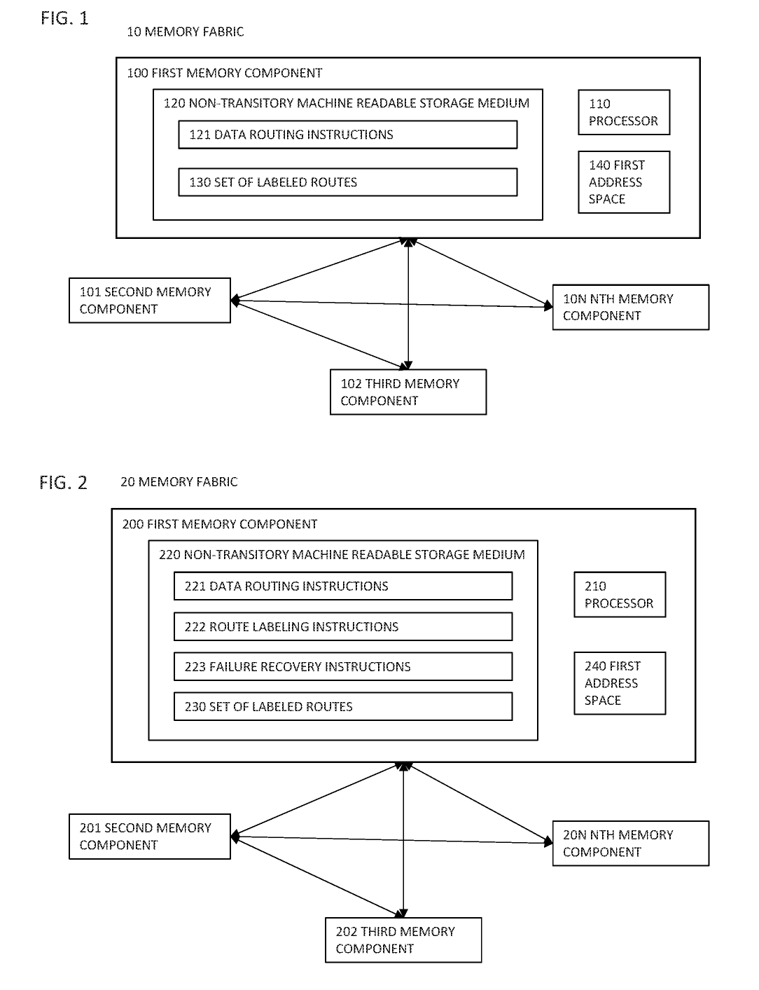

Referring now to the drawings, FIG. 1 is a block diagram of an example resilient memory fabric 10. In the example depicted in FIG. 1, memory fabric 10 comprises a network of memory components 100, 101, 102, . . . , 10n. The memory components may be connected to each other via optical interconnects. In some examples, each memory component in the memory fabric 10 may be connected to at least one other memory component in the memory fabric 10, but may not be connected to all other memory components in the memory fabric 10.

A memory component (e.g., first memory component 100) may comprise a non-transitory machine-readable storage medium 120, a processor 110, and a first address space 140 of memory. Each memory component 100, 101, 102, . . . , 10n may comprise similar or the same hardware and perform the same functionality as described below in conjunction with memory component 100.

Processor 110 may be one or more central processing units (CPUs), graphic processing units (GPUs), digital signal processors (DSPs), microprocessors, and/or other hardware devices suitable for retrieval and execution of instructions stored in machine-readable storage medium 120. Processor 110 may fetch, decode, and execute program instructions 121, and/or other instructions to enable management of a resilient memory fabric, as described below. As an alternative or in addition to retrieving and executing instructions, processor 110 may include one or more electronic circuits comprising a number of electronic components for performing the functionality of one or more of instructions 121, and/or other instructions.

In one example, the program instructions 121, and/or other instructions can be part of an installation package that can be executed by processor 110 to implement the functionality described herein. In this case, memory 120 may be a portable medium such as a CD, DVD, or flash drive or a memory maintained by a computing device from which the installation package can be downloaded and installed. In another example, the program instructions may be part of an application or applications already installed on memory fabric 10.

Non-transitory machine-readable storage medium 120 may be any hardware storage device for maintaining data accessible to memory fabric 10. For example, machine-readable storage medium 120 may include one or more hard disk drives, solid state drives, tape drives, memory fabrics, and/or any other storage devices. The storage devices may be located in memory fabric 10, may be located across disparate, geographically distributed devices, and/or in another device in communication with memory fabric 10. For example, machine-readable storage medium 120 may be any electronic, magnetic, optical, or other physical storage device that stores executable instructions. Thus, machine-readable storage medium 120 may be, for example, Random Access Memory (RAM), an Electrically-Erasable Programmable Read-Only Memory (EEPROM), a storage drive, an optical disc, universal memory, and the like. As described in detail below, machine-readable storage medium 120 may be encoded with executable instructions for management of a resilient memory fabric. As detailed below, storage medium 20 may maintain and/or store the data and information described herein.

For example, storage medium 120 may maintain and/or store data and information related to management of a resilient memory fabric. Storage medium 120 may store, for example, information about the memory components of the memory fabric 10. In some examples, the storage medium 120 may store information about each memory component of the memory fabric 10. For an individual memory component, the storage medium 120 may store, for example, an identification of the memory component, an indication of whether the memory component is a neighbour (e.g., directly connected to) the memory component 100, and/or other information related to the memory component.

Storage medium 120 may also store, for example, a set of labelled routes from the memory component 100 to other memory components (e.g., memory components 100, 101, 102, . . . , 10n) in the memory fabric 10. Information about a route may comprise, for example, an ordered series of memory components, information about links between the memory components, corresponding output ports, a cost metric associated with the route, and/or other information related to the route. The label may comprise, for example, an identification of a route, an identification of the destination memory component of the route, a cost metric of the route, a number of memory components in the route, and/or other information related to the route. In some examples, the label may also comprise an indication that a route is an alternative route (e.g., not a route to be selected for use by the memory component).

Data routing instructions 121, when executed by processor 110, may route data from the memory component 101 to a destination memory component. For example, the data routing instructions 121, when executed by processor 110, may route data along a selected labelled route. The data routing instructions 121, when executed by processor 110, may select the labelled route based on the destination memory component. For example, the data routing instructions 121, when executed by processor 110, may determine which label of the set of labelled routes stored in the non-transitory machine readable storage medium comprises an identification of the destination memory component. In some examples, the data routing instructions 121, when executed by processor 110, may determine that a plurality of labels comprise the identification of the destination memory component. In these examples, the data routing instructions 121, when executed by processor 110, may determine the labelled route via which to route data based on whether each of the plurality of labels also comprise an indication that the route is an alternative route. The data routing instructions 121, when executed by processor 110, may select the labelled route that does not include such an indication.

FIG. 2 is a block diagram of an example memory fabric 20. As with memory fabric 10, memory fabric 20 may comprise a network of memory components 200, 201, 202, . . . , 10n, and/or any other device suitable for executing the functionality described below,. As with the memory components of FIG. 1, the memory components of FIG. 2 may be connected to each other via optical interconnects. In some examples, each memory component in the memory fabric 20 may be connected to at least one other memory component in the memory fabric 20, but may not be connected to all other memory components in the memory fabric 20.

Like the memory components of FIG. 1, the memory components of FIG. 2 (e.g., first memory component 200) may comprise a non-transitory machine-readable storage medium 220, a processor 210, and a first address space 240 of memory. Each memory component 201, 202, 203, . . . , 20n may comprise similar or the same hardware and perform the same functionality as described below in conjunction with memory component 200.

As with processor 110 of FIG. 1, processor 210 may be one or more CPUs, GPUs, DSPs, microprocessors, and/or other hardware devices suitable for retrieval and execution of instructions (e.g., instructions 221, 222, 223, and/or other instructions). The non-transitory machine readable storage 220 of FIG. 2 may be the same as or similar to the storage medium 120 of FIG. 1. Non-transitory machine-readable storage medium 220 of FIG. 2 may store information related to the memory fabric. In some examples, the information stored by non-transitory machine-readable storage medium 220 may be the same as or similar to information stored by non-transitory machine-readable storage medium 120. In some examples, non-transitory machine readable storage medium 220 may store the set of labelled routes similar to the set of labelled routes stored by the non-transitory machine readable storage medium 120 of FIG. 1

Data routing instructions 221, when executed by processor 210, may route data from the memory component 200 to a destination memory component. In some examples, data routing instructions 221, when executed by processor 210, may perform functionality the same as or similar o data routing instructions 121, when executed by processor 110.

Route labelling instructions 222, when executed by processor 210, may determine a set of routes to other memory components in the memory fabric 10. For example, the route labelling instructions 222, when executed by processor 210, may perform routing to each of the other memory components and may determine, based on the performed routing, a cost metric for each route. The route labelling instructions 222, when executed by processor 210, may determine a cost metric for a route based on, for example, a latency of the route, a number of hops for the route, bandwidth for the route (and/or for memory components in the route), reliability of transmission across the route, any combination thereof, and/or other objective measures of successful transmission of data along the route.

The route labelling instructions 222, when executed by processor 210, may access the objective measures to be used to determine the cost metric from the non-transitory machine readable storage medium 220, from an administrator of the memory fabric 20, and/or from another source. In some examples, the objective measures may vary based on characteristics of the memory components or the memory fabric. In some examples, different sets of objective measures may be used for different types of memory components in a memory fabric 20.

Responsive to determining the routes and the respective cost metrics for each route, the route labelling instructions 222, when executed by processor 210, may store information about the routes in the non-transitory machine readable storage medium 120. Information about a route may comprise, for example, ordered series of memory components, information about links between the memory components, corresponding output ports, a cost metric associated with the route, and/or other information related to the route.

The route labelling instructions 222, when executed by processor 210, may label the determined routes. For example, route labelling instructions 222, when executed by processor 210, may label the determined routes based on the determined cost metric for each route. In some examples, the route labelling instructions, when executed by processor 210, may determine which route to a destination memory component has the best cost metric (e.g., lowest or highest cost metric based on the characteristics of the cost metric) and may label only that route. A label for each route may comprise, for example, an identification of a route, an identification of the destination memory component of the route, a cost metric of the route, a number of memory components in the route, and/or other information related to the route. In some examples, route labelling instructions 222, when executed by processor 210, may label each route stored in the non-transitory machine-readable storage medium. In these examples, the label may also comprise an indication that a route is an alternative route (e.g., not a route to be selected for use by the memory component). The route labelling instructions 222, when executed by processor 210, may store the set of labelled routes in the non-transitory machine readable storage medium 220.

Responsive to storing the set of labelled routes in the storage medium 220, the route labelling instructions 222, when executed by processor 210, may forward, to each neighbour component of the first memory component 200, information about the stored set of labelled routes. The forwarded information may comprise, for each labelled route, the label, the cost metric, the identification of the memory component, and/or other information related to the route. In some examples in which all routes are labelled and some routes have labels with an indication that they are alternative routes, the route labelling instructions 222, when executed by processor 210, may only forward those labelled routes that are not alternative routes.

The route labelling instructions 222, when executed by processor 210, may similarly receive, from each neighbour memory component, information about the respective neighbor's stored set of labelled routes. The route labelling instructions 222, when executed by processor 210, may revise its stored set of labelled routes based on the received information. For example, for each labelled route of a first neighbor's set of labelled routes, the route labelling instructions 222, when executed by processor 210, may determine, from the received information, whether a neighbor identification of a destination memory component of the labelled route matches a local identification of a destination memory component in a labelled route for that destination memory component stored in the storage medium 120.

Responsive to the neighbor identification matching the local identification, the route labelling instructions 222, when executed by processor 210, may determine whether a neighbor cost metric associated with the labelled route is better than the cost metric associated with the stored labelled route. Responsive to the neighbor cost metric being lower than the associated cost metric, the route labelling instructions 222, when executed by processor 210, may store the received labelled route from the neighbour memory component in the storage medium 220. The route labelling instructions 222, when executed by processor 210, may also remove the label of the stored route and label the stored neighbor label associated with the neighbor identification of the destination memory component. In some examples, instead of removing the label of the stored route, the route labelling instructions 222, when executed by processor 210, may revise the label of the stored route with an indication that the stored route is an alternative route.

The route labelling instructions 222, when executed by processor 210, may continue to forward and receive stored sets of labelled routes and revise the stored labelled routes of the memory components until no changes are made to the stored labelled routes responsive to receiving a stored set of labelled routes from other memory components. The route labelling instructions 222, when executed by processor 210, may forward and receive stored sets of labelled routes responsive to a cost metric for a stored route changing, responsive to receiving information from the memory fabric 20 (or a memory component thereof) to forward and receive stored sets of labelled routes, and/or in other situations where the labelled routes should be updated.

In some examples, each time the route labelling instructions 222, when executed by processor 210, may store and/or revise a labelled route, the route labelling instructions 222, when executed by processor 210, may send the stored and/or revised labelled route (or its entire set of labelled routes) to a central non-transitory storage medium of the memory fabric 20. In some examples, a single memory component or other hardware component of the memory fabric may comprise the central storage medium. In some examples, the storage medium may comprise the labelled routes from each of the memory components of the memory fabric 20. In some examples, information about each route available via the memory components of the memory fabric 20 may be stored at the central storage medium, with labels for the routes including indications as to whether the route is an alternative route.

Failure recovery instructions 223, when executed by processor 210, may facilitate recovery responsive to a failure in the memory fabric 20. For example, the failure recovery instructions 223, when executed by processor 220, may receive information about a memory component, link, and/or other component of the memory fabric 20 failing.

Responsive to determining that the failure involves a particular memory component, the failure recovery instructions 223, when executed by processor 220, may determine that a labeled route to a destination memory component in the set of labeled routes stored in the local non-transitory machine readable storage medium comprises the failed memory component. For example, the failure recovery instructions 223, when executed by processor 220, may determine whether each labelled route stored in the storage medium 220 (that does not have an indication of alternative route in the label) comprises the failed memory component. Responsive to determining that a labelled route comprises the failed memory component, the failure recovery instructions 223, when executed by processor 220, may remove the label associated with the labelled route and/or may revise the label to indicate that the label comprises the failed memory component.

Responsive to determining that the labelled route comprises the failed memory component, the failure recovery instructions 223, when executed by processor 220, may also determine whether other routes are stored to the destination memory component of the labelled route that comprises the failed memory component. The failure recovery instructions 223, when executed by processor 220, may determine which one of the other routes stored in the storage medium 120 has the best cost metric and may label that route and store the labelled route in the storage medium 120. In some examples, the failure recovery instructions 223, when executed by processor 220, may determine the other routes from labelled routes that comprise information indicating that the labelled route is an alternative route. In some examples, the failure recovery instructions 223, when executed by processor 220, may obtain information about the other routes from the central storage medium of the memory fabric 20.

Responsive to determining that the failure involves a particular link between two memory components, the route labelling instructions 222, when executed by processor 210, may determine which routes comprise the failed link and may select an alternative route in a manner similar to that described with a failed memory component.

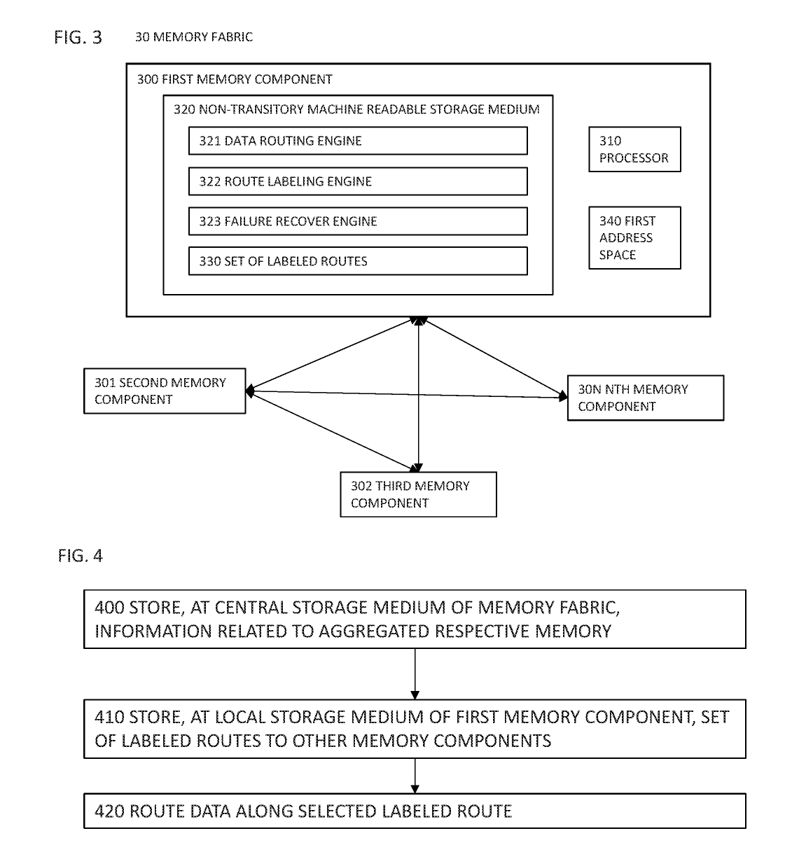

FIG. 3 is an example memory fabric 20. As with memory fabric 10, memory fabric 30 may comprise a network of memory components 301, 302, 303, . . . , 30n, and/or any other device suitable for executing the functionality described below. As with the memory components of FIG. 1, the memory components of FIG. 3 may be connected to each other via optical interconnects. In some examples, each memory component in the memory fabric 30 may be connected to at least one other memory component in the memory fabric 30, but may not be connected to all other memory components in the memory fabric 30.

Like the memory components of FIG. 1, the memory components of FIG. 3 (e.g., first memory component 300) may comprise a non-transitory machine-readable storage medium 320, a processor 310, and a first address space 340 of memory. Each memory component 300, 301, 302, . . . , 30n may comprise similar or the same hardware and perform the same functionality as described below in conjunction with memory component 300.

As with processor 110 of FIG. 1, processor 310 may be one or more CPUs, GPUs, DSPs, microprocessors, and/or other hardware devices suitable for retrieval and execution of instructions. The non-transitory machine readable storage of FIG. 3 may be the same as or similar to the storage medium 120 of FIG. 1. Non-transitory machine-readable storage medium of FIG. 3 may store information related to the initialization vectors associated with each page of memory in the non-transitory machine-readable storage medium. In some examples, the information stored by non-transitory machine-readable storage medium may be the same as or similar to information stored by non-transitory machine-readable storage medium 120.

As detailed below, system 300 may include a series of engines 320, 330, 340 for managing a resilient memory fabric. Each of the engines may generally represent any combination of hardware and programming. For example, the programming for the engines may be processor executable instructions stored on a non-transitory machine-readable storage medium and the hardware for the engines may include at least one processor of the system 300 to execute those instructions. In addition or as an alternative, each engine may include one or more hardware devices including electronic circuitry for implementing the functionality described below.

Data routing engine 320 may route data from the memory component 300 to a destination memory component by selecting a labelled route via which to route the data. In some examples, the data routing engine 320 may facilitate routing data in a manner the same as or similar to that of the data routing instructions 121 of memory fabric 10, data routing instructions 221 of memory fabric, 20, and/or other instructions. Further details regarding an example implementation of data routing engine 320 are provided above in connection with data routing instructions 121 of FIG. 1 and/or data routing instructions 221 of FIG. 2.

Route labelling engine 330 may determine and label routes to destination memory components. In some examples, the route labelling engine 330 may determine and label routes to destination memory components in a manner the same as or similar to that of the route labelling instructions 222 of memory fabric, 20, and/or other instructions. Further details regarding an example implementation of route labelling engine 330 are provided above in connection with route labelling instructions 222 of FIG. 2.

Failure recovery engine 340 may receive information about a failure in the network of memory components of the memory fabric and may mitigate the failure by selecting an alternative labelled route to a destination memory component. In some examples, the failure recovery engine 340 may mitigate failure in the memory fabric in a manner the same as or similar to that of the failure recovery instructions 223 of memory fabric, 20, and/or other instructions. Further details regarding an example implementation of failure recovery engine 340 are provided above in connection with failure recovery instructions 223 of FIG. 2.

FIG. 4 is a flowchart of an example method for execution by a resilient memory fabric.

Although execution of the methods described below are with reference to memory fabric 10 of FIG. 1, memory fabric 20 of FIG. 2, and/or memory fabric 30 of FIG. 3, other suitable devices for execution of this method will be apparent to those of skill in the art. The method described in FIG. 4 and other figures may be implemented in the form of executable instructions stored on a machine-readable storage medium, such as storage medium 120 or storage medium 220, by one or more engines described herein, and/or in the form of electronic circuitry.

In an operation 400, information related to a memory fabric may be stored at a central non-transitory machine readable storage medium of a memory fabric, where the memory fabric may comprise a network of memory components and each memory component may comprise a respective address space, such that the memory fabric comprises the aggregated respective memory as a single addressable memory space. For example, the memory fabric 10 (and/or the memory fabric 20, memory fabric 30, or other resource of the memory fabric) may store the information related to the aggregated respective memory. The memory fabric 10 may store the information in a manner similar or the same as that described above in relation to the execution of the memory fabric 10, the memory fabric 20, the memory fabric 30, and/or other resource of the memory fabric.

In an operation 410, information related to a set of labelled routes to other memory components in the memory fabric may be stored at a local non-transitory machine readable storage medium of a memory component of the memory fabric. For example, the memory fabric 10 (and/or the memory fabric 20, memory fabric 30, or other resource of the memory fabric) may store the set of labelled routes. The memory fabric 10 may store the set of labelled routes in a manner similar or the same as that described above in relation to the execution of the memory fabric 10, the memory fabric 20, the memory fabric 30, and/or other resource of the memory fabric.

In an operation 420, data may be routed by the first memory component along a selected labelled route. For example, the memory fabric 10 (and/or the data routing instructions 121, the data routing instructions 221, the data routing engine 3200, or other resource of the memory fabric 10) may route the data along the selected labelled route. The memory fabric 10 may route the data along the selected labelled route in a manner similar or the same as that described above in relation to the execution of the data routing instructions 121, the data routing instructions 221, the data routing engine 320, or other resource of the memory fabric 10.

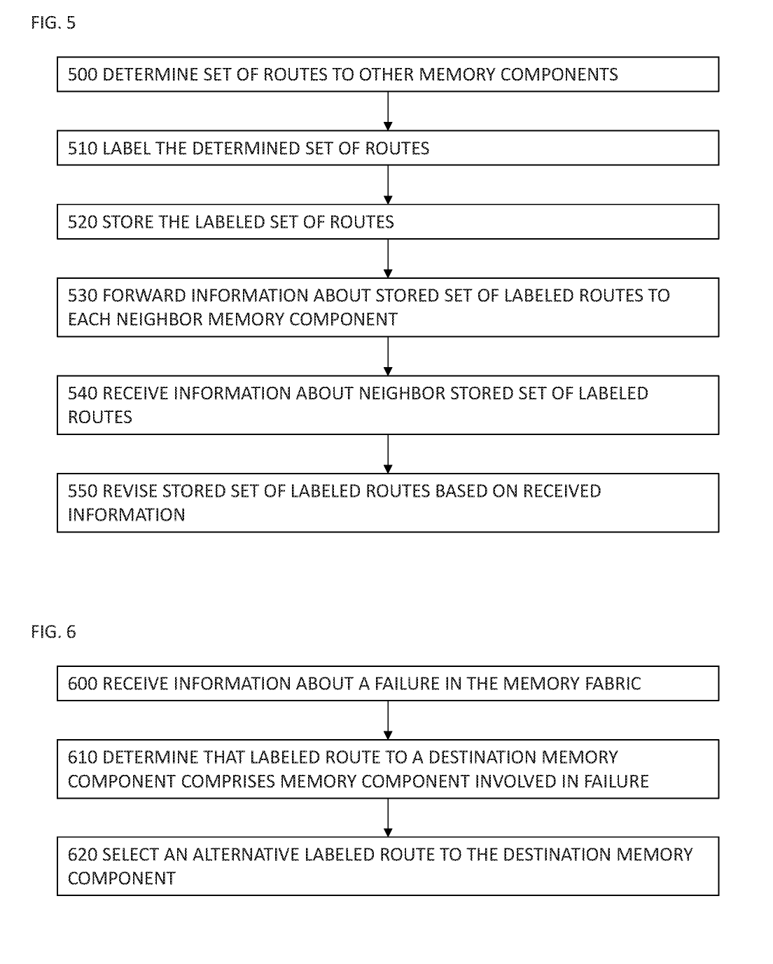

FIG. 5 is a flowchart of an example method for execution by resilient memory fabric.

In an operation 500, a memory component may determine a set of routes to other memory components in the memory fabric. For example, the memory fabric 20 (and/or the route labelling instructions 222, the route labelling engine 222, or other resource of the memory fabric 20) may determine the set of routes. The memory fabric 20 may determine the set of routes in a manner similar or the same as that described above in relation to the execution of the route labelling instructions 222, the route labelling engine 222, and/or other resource of the memory fabric 20.

In an operation 510, the memory component may label the determined set of routes. For example, the memory fabric 20 (and/or route labelling instructions 222, the route labelling engine 222, or other resource of the system 300) may label the determined set of routes. The memory fabric 20 may label the determined set of routes in a manner similar or the same as that described above in relation to the execution of the route labelling instructions 222, the route labelling engine 222, or other resource of the memory fabric 20.

In an operation 520, the memory component may store the labelled set of routes in a local non-transitory machine readable storage medium. For example, the memory fabric 20 (and/or the route labelling instructions 222, the route labelling engine 222, or other resource of the memory fabric 20) may store the set of labelled routes. The memory fabric 20 may store the set of labelled routes in a manner similar or the same as that described above in relation to the execution of the route labelling instructions 222, the route labelling engine 222, and/or other resource of the memory fabric 20.

In an operation 530, the memory component may forward information about the stored set of labelled routes to each neighbour memory component. For example, the memory fabric 20 (and/or the route labelling instructions 222, the route labelling engine 222, or other resource of the memory fabric 20) may forward the set of labelled routes. The memory fabric 20 may forward the set of labelled routes in a manner similar or the same as that described above in relation to the execution of the route labelling instructions 222, the route labelling engine 222, and/or other resource of the memory fabric 20.

In an operation 540, the memory component may receive information about its neighbors' stored sets of labelled routes. For example, the memory fabric 20 (and/or the route labelling instructions 222, the route labelling engine 222, or other resource of the memory fabric 20) may receive information about its neighbor's stored sets of labelled routes. The memory fabric 20 may receive information about its neighbor's stored sets of labelled routes in a manner similar or the same as that described above in relation to the execution of the route labelling instructions 222, the route labelling engine 222, and/or other resource of the memory fabric 20.

In an operation 550, the memory component may revise its stored set of labelled routes based on the received information. For example, the memory fabric 20 (and/or the route labelling instructions 222, the route labelling engine 222, or other resource of the memory fabric 20) may revise the set of labelled routes. The memory fabric 20 may revise the set of labelled routes in a manner similar or the same as that described above in relation to the execution of the route labelling instructions 222, the route labelling engine 222, and/or other resource of the memory fabric 20.

FIG. 6 is a flowchart of an example method for failure recovery by a resilient memory fabric.

In an operation 600, the memory component may receive information about a failure in the memory fabric. For example, the memory fabric 20 (and/or the failure recovery instructions 223, the failure recovery engine 323, or other resource of the memory fabric 20) may receive information about a failure in the memory fabric. The memory fabric 20 may receive information about a failure in the memory fabric in a manner similar or the same as that described above in relation to the execution of the failure recovery instructions 223, the failure recovery engine 323, and/or other resource of the memory fabric 20.

In an operation 610, the memory component may determine that the labelled route to a destination memory component comprises a memory component involved in the failure. For example, the memory fabric 20 (and/or the failure recovery instructions 223, the failure recovery engine 323, or other resource of the memory fabric 20) may determine that the labelled route to a destination memory component comprises a memory component involved in the failure. The memory fabric 20 may determine that the labelled route to a destination memory component comprises a memory component involved in the failure in a manner similar or the same as that described above in relation to the execution of the failure recovery instructions 223, the failure recovery engine 323, and/or other resource of the memory fabric 20.

In an operation 620, the memory component may select an alternative labelled route to the destination memory component. For example, the memory fabric 20 (and/or the failure recovery instructions 223, the failure recovery engine 323, or other resource of the memory fabric 20) may select an alternative labelled route to the destination memory component. The memory fabric 20 may select an alternative labelled route to the destination memory component in a manner similar or the same as that described above in relation to the execution of the failure recovery instructions 223, the failure recovery engine 323, and/or other resource of the memory fabric 20.

The foregoing disclosure describes a number of example embodiments for a resilient memory fabric. The disclosed examples may include systems, devices, computer-readable storage media, and methods for management of a resilient memory fabric. For purposes of explanation, certain examples are described with reference to the components illustrated in FIGS. 1-6. The functionality of the illustrated components may overlap, however, and may be present in a fewer or greater number of elements and components. Further, all or part of the functionality of illustrated elements may co-exist or be distributed among several geographically dispersed locations. Moreover, the disclosed examples may be implemented in various environments and are not limited to the illustrated examples.

Further, the sequence of operations described in connection with FIGS. 1-6 are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples. All such modifications and variations are intended to be included within the scope of this disclosure and protected by the following claims.

1. A resilient memory fabric comprising:
a network of memory components, each memory component comprising a respective address space, wherein the memory fabric comprises the aggregated respective memory as a single addressable memory space;
wherein a first memory component of the network of memory components comprises:
a first memory local non-transitory machine readable storage medium that stores a set of labeled routes to other memory components in the memory fabric;
a first memory processor that executes machine-readable instructions that cause the first memory component to:
route data along a selected labeled route.

2. The first memory component of the memory fabric of claim 1, the first memory processor executing instructions that cause the first memory component to:
determine a set of routes to the other memory components in the memory fabric;
label the determined set of routes, wherein a label comprises an identification of a route and an identification of a destination memory component of the route; and
store the set of labeled routes in the first memory local non-transitory machine readable storage medium.

3. The first memory component of the memory fabric of claim 2, the first memory processor executing instructions that cause the first memory component to determine and label the set of routes by:
performing routing to each of the other memory components;
determining, based on the routing, a cost metric for each route;
assigning, for each of the other memory components, a respective label for a respective route, the respective label comprising information about a route with a lowest determined cost metric and the associated lowest determined cost metric.

4. The first memory component of the memory fabric of claim 2, the first memory processor executing instructions that cause the first memory component to:
forward, to each neighbor memory component of the first memory component, information about the stored set of labeled routes, the information comprising, for each labeled route, the label, the associated cost metric, and the identification of the destination memory component;
receive, from each neighbor memory component, information about the neighbor stored set of labeled routes; and
revise the stored set of labeled routes based on the received information.

5. The first memory component of the memory fabric of claim 4, the first memory processor executing instructions that cause the first memory component to revise the stored set of labeled routes by:
determining, from the received information, whether a neighbor identification of a destination memory component from the received information matches a local identification of a destination memory component;
responsive to the neighbor identification matching the local identification, determining whether a neighbor cost metric associated with the neighbor identification is lower than the cost metric associated with the local identification;
responsive to the neighbor cost metric being lower than the associated cost metric, replacing the label of the local route associated with the local identification of the destination memory component with the neighbor label associated with the neighbor identification of the destination memory component; and
storing the replaced labeled local route in the local non-transitory machine-readable storage medium.

6. The first memory component of the memory fabric of claim 4, the first memory processor executing instructions that cause the first memory component to revise the stored set of labeled routes by:
responsive to the neighbor cost metric being lower than the associated cost metric, maintaining storage of the labeled route; and
associating the labeled route with an indication that the labeled route is an alternative route.

7. The first memory component of the memory fabric of claim 1, the first memory processor executing instructions that cause the first memory component to:
receive information about a failure in the network of memory components;
responsive to determining that the failure involves a particular memory component, determine that a labeled route to a destination memory component in the set of labeled routes stored in the local non-transitory machine readable storage medium comprises the particular memory component;
select an alternative labeled route to the destination memory component as a selected labeled route to the destination memory component, wherein the alternative labeled route comprises a label with information indicating that the alternative labeled route is an alternative route.

8. The first memory component of the memory fabric of claim 7, the first memory processor executing instructions that cause the first memory component to:
select the alternative labeled route from the local non-transitory machine readable storage medium.

9. The first memory component of the memory fabric of claim 7, the first memory processor executing instructions that cause the first memory component to:
select the alternative labeled route from a central non-transitory machine readable storage medium of the memory fabric.

10. A method of managing a resilient memory fabric, the method comprising:
storing, at a central non-transitory machine readable storage medium of the memory fabric, information related to the memory fabric, wherein the memory fabric comprises a network of memory components, each memory component comprising a respective address space, wherein the memory fabric comprises the aggregated respective memory as a single addressable memory space;
storing, at a first memory local non-transitory machine readable storage medium of a first memory component of the memory fabric, a set of labeled routes to other memory components in the memory fabric; and
routing, by a first memory processor of the first memory component that executes machine-readable instructions, data along a selected labeled route.

11. The method of claim 10, further comprising:
determining, by the first memory processor, a set of routes to the other memory components in the memory fabric;
labeling, by the first memory processor, the determined set of routes, wherein a label comprises an identification of a route, a cost metric associated with the route, and an identification of a destination memory component of the route; and
storing, by the first memory processor at the local non-transitory machine-readable storage medium, the set of labeled routes.

12. The method of claim 11, further comprising:
forwarding, by the first memory processor to each neighbor memory component of the first memory component, information about the stored set of labeled routes, the information comprising, for each labeled route, the label, the associated cost metric, and the identification of the destination memory component;
receiving, by the first memory processor from each neighbor memory component, information about the neighbor stored set of labeled routes; and
revising, by the first memory processor, the stored set of labeled routes based on the received information.

13. The method of claim 12, wherein revising the stored set of labeled routes comprises:
determining, by the first memory processor from the received information, whether a neighbor identification of a destination memory component from the received information matches a local identification of a destination memory component;
responsive to the neighbor identification matching the local identification, determining, by the first memory processor, whether a neighbor cost metric associated with the neighbor identification is lower than the cost metric associated with the local identification;
responsive to the neighbor cost metric being lower than the associated cost metric, replacing, by the first memory processor, the label of the local route associated with the local identification of the destination memory component with the neighbor label associated with the neighbor identification of the destination memory component; and
storing, by the first memory processor, the replaced labeled local route in the local non-transitory machine-readable storage medium.

14. The method of claim 13, further comprising:
responsive to the neighbor cost metric being lower than the associated cost metric, maintaining storage of the labeled route; and
associating, by the first memory processor, the labeled route with an indication that the labeled route is an alternate route.

15. The method of claim 14, further comprising:
receiving, by the first memory processor, information about a failure in the network of memory components;
responsive to determining that the failure involves a particular memory component, determining, by the first memory processor, that a labeled route to a destination memory component in the set of labeled routes stored in the local non-transitory machine readable storage medium comprises the particular memory component;
selecting, by the first memory processor, an alternative labeled route to the destination memory component as a selected labeled route to the destination memory component, wherein the alternative labeled route comprises a label with information indicating that the alternative labeled route is an alternate route.
